(19) United States
(12) Patent Application Publication
(10) Pub. No.: US 2007/0156527 A1
(43) Pub. Date: Jul. 5, 2007

(54) SYSTEM AND METHOD FOR PROMOTING ADVERTISEMENT GENERATED REVENUE VIA THE INTERNET

(76) Inventor: Avigdor Rubinstein, Bnei Brak (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/614,273

(22) Filed: Dec. 21, 2006

(30) Foreign Application Priority Data
Dec. 29, 2005 (IL) 172907

(51) Int. Cl. G06Q 30/00

(52) U.S. Cl. 705/14

(57) ABSTRACT

A method and system for promoting advertisement generated revenue are disclosed. Each of a plurality of stored advertiser web pages which are displayable without any initial advertising costs can be searched and loaded by means of a plurality of customer terminals in communication with a service provider website via a data network. After user-initiated loading of a selected advertiser web page, an advertiser account is debited by a predetermined sum upon completion of an advertiser chargeable operation associated by predetermined criteria with the loading of the selected advertiser web page. A user account is then credited with a service provider payable remuneration. The value of the remuneration is based on the predetermined sum debited to the advertiser account.

### FIELD OF THE INVENTION

The present invention relates to the field of electronic commerce. More particularly, the invention relates to a system and method for promoting advertisement generated revenue via the Internet.

### BACKGROUND OF THE INVENTION

Advertisements that are displayable on the Internet and conventional offline advertisements are both used to attract potential customers to an advertised product or service. Each prior art advertising method, such as newspaper and television advertisements, has attempted to attract potential customers in different ways, each of which being associated with a different design and market approach in order to attract the attention of a potential customer. Advertisers therefore traditionally allot a considerable budget to develop and distribute unique advertisements which will attract the attention of potential customers and will stimulate an increase of sales of products being advertised.

Advertisers therefore have been seeking a method by which sales of a selected product or service may be increased while advertising costs may be decreased.

One method disclosed in US 2005/0015299 presents an advertising message with an unexpected price reduction at a point of purchase location for a current transaction between the customer and the merchant. The advertiser may compensate the merchant for the amount of price reduction or a portion thereof.

Another method disclosed in US 2005/0234775 involves generating commissions for an affiliate that promotes an end-user transaction of a merchant. An affiliate is assigned an affiliate identifier, and a user-initiated transaction in response to a referral from the affiliate is associated with the affiliate identifier. A payment for the affiliate based on compensation terms is determined after receiving confirmation that the user-initiated transaction produced the consumed transaction.

In all of these aforementioned advertising methods, the potential customer passively views the advertisement. In other words, the driving force for viewing the advertisement is the advertiser, who attracted a potential customer to the advertisement by means of a selected marketing approach. If the potential customer was not accessible to the medium by which the advertisement became known, the potential customer would not have been aware of the advertisement, and most likely, of the advertised product or service.

If a potential customer, in contrast, were the driving force for viewing a advertisement, in order to purchase a desired product or service, many more advertisers would be interested in advertising since a significantly high percentage of those that initiated a request to view an advertisement would actually consummate a transaction. The number of advertisements would further increase if advertisement costs could be reduced, resulting in corresponding reduced costs to the costumer.

It is an object of the present invention to provide a system and method by which sales of a selected product or service may be increased while advertising costs may be decreased.

It is an additional object of the present invention to provide a system and method by which a potential customer initiates the viewing of an advertisement prior to purchasing a product or service.

Other objects and advantages of the invention will become apparent as the description proceeds.

### SUMMARY OF THE INVENTION

The present invention provides a method for promoting advertisement generated revenue, comprising the following steps:
a) Providing a service provider website suitable for searching and loading each of a plurality of stored advertiser web pages which are displayable without any initial advertising costs;
b) User-initiated loading of a selected advertiser web page;
c) Debiting an advertiser account by a predetermined sum upon completion of an advertiser chargeable operation associated by predetermined criteria with said loading of said selected advertiser web page; and
d) Crediting a user account with a service provider payable remuneration, the value of said remuneration being based on said predetermined sum debited to said advertiser account.

In one embodiment of the invention, the advertiser chargeable operation is a purchase of a merchantable item.

Accordingly, advertisement generated revenue is accrued by performing the following steps:
a) Loading a merchant web page and viewing a corresponding advertisement of a merchantable item;
b) Submitting a request to purchase said merchantable item;
c) Consummating a customer-initiated purchase of said merchantable item by transmitting payment information;
d) Debiting the advertiser account by the predetermined sum;
e) Issuing a receipt to the customer for said purchase;
f) Transferring the predetermined sum to a service provider bank account;
g) Crediting the user account with the service provider payable remuneration; and
h) Transferring the remuneration from the service provider bank account to a customer bank account after the balance of the user account is greater than a predetermined balance.

In one embodiment of the invention, the advertiser chargeable operation is candidate success in a predetermined election.

The present invention is also directed to a system for promoting advertisement generated revenue, comprising:
a) A service provider website dedicated to displaying a plurality of advertisements for various types of merchantable items which are displayable without any initial advertising costs, said service provider website comprising-
   i. a database in which are stored customer and merchant account information and a listing of displayable advertisements associated with corresponding merchantable items;
   ii. a search engine by which merchantable items are searchable;
   iii. a server for communicating with a suitable data network and for loading a merchant web page retrieved by said search engine;
   iv. a payment module in communication with said server adapted to execute a transaction from a customer to a merchant, from the service provider to a customer, or from an advertiser to the service provider;
   v. a monitoring module in communication with said server adapted to determine which customers, by means of the service provider website, loaded a given merchant web page and which customers consummated a purchase by means of the service provider website; and
   vi. a purchase verifying module interfacing with said monitoring module and information obtainable from a credit card company, said purchase verifying module adapted to determine which customers purchased a merchantable item after loading the advertisement of the merchantable item by means of the service provider website; and
b) a plurality of customer terminals in communication with said data network, for interacting with said service provider website,
   wherein a purchase is capable of being consummated by means of a customer terminal and said payment module following the loading of a selected advertiser web page and the entering of suitable payment information, said server being operable to automatically debit a merchant account by a predetermined sum and to automatically credit a customer account by a remuneration the value of which being based on said predetermined sum upon consummation of said purchase.

### BRIEF DESCRIPTION OF THE DRAWINGS

In the drawings:

FIG. 1 is a schematic drawing of an advertisement generated revenue promoting system, according to one embodiment of the invention;

FIG. 2 is a schematic drawing of an exemplary merchant web page;

FIG. 3 is a flow chart of an advertisement generated revenue promoting method, according to one embodiment of the invention;

FIG. 4 is a schematic drawing of a merchantable item on the wrapping of which is printed a serial number;

FIG. 5 is a schematic drawing of an evaluation module in communication with a service provider server; and

FIG. 6 is a flow chart of a method for evaluating a merchantable item.

### DETAILED DESCRIPTION OF PREFERRED EMBODIMENTS

The present invention is a novel system and method for promoting advertisement generated revenue by which the sales of a given product tend to increase without a concomitant increase in required advertising expenditures.

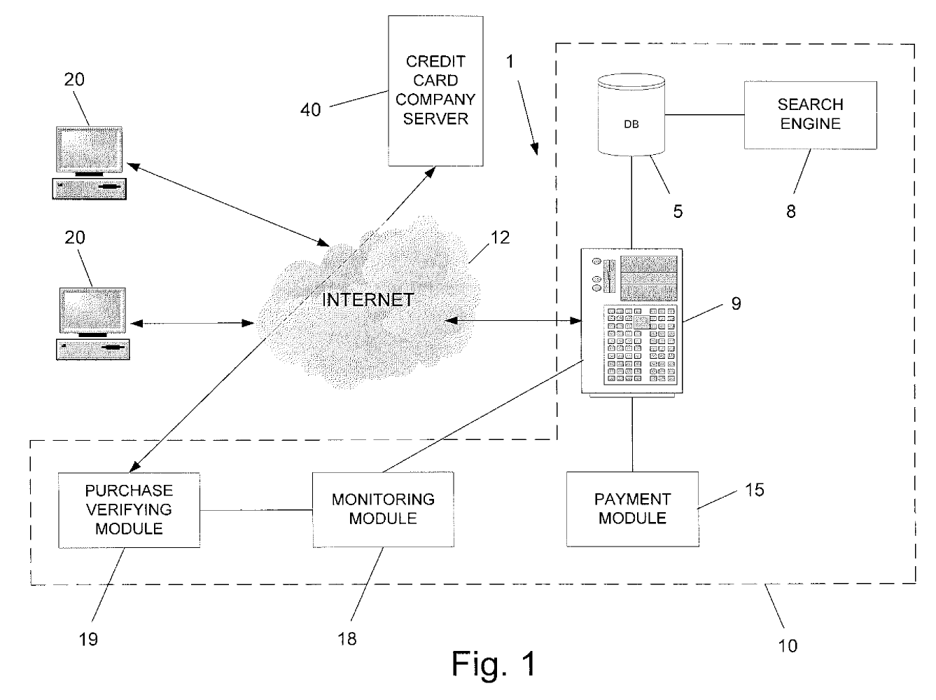

FIG. 1 schematically illustrates a system for promoting advertisement generated revenue, according to one embodiment of the invention, and is designated generally by numeral 1. System 1 comprises website 10, which is dedicated to displaying a plurality of advertisements 3 for various types of goods and services (hereinafter “merchantable items”). Website 10 is managed by an administrator (hereinafter “the service provider”) that finalizes working agreements with merchants who advertise their merchantable items on the website and with potential customers that view the displayed advertisements. To encourage as many advertisers as possible to advertise their merchantable items on website 10 (hereinafter “the service provider website”), advertisers are allowed to advertise initially for free. If merchantable items are “purchased”, i.e. a transaction is conducted at a point of purchase or remotely via the Internet 12 or any other suitable communication network, after a customer has viewed an advertisement that is displayed on the service provider website, the advertiser is required to pay a predetermined sum to the service provider. To encourage as many customers as possible to interact with the service provider website and to view the advertisements that are displayable thereby, the service provider presents a remuneration to a customer that purchased merchantable items being advertised in the service provider website. The customer is presented with a remuneration which is a percentage, e.g. half, of the predetermined sum paid to the service provider by the advertiser. Payment of the predetermined sum from a merchant to the service provider, or of the remuneration from the service provider to a customer, is conducted automatically by system 1.

The predetermined sum that the merchant is obliged to the service provider is generally a percentage of the cost of the merchantable item, e.g. 2%. In some industries, such as those that have a high overhead or the markup value of the merchantable item is relatively low due to the high level of competition, the predetermined sum may be a fixed sum. Alternatively, the merchant may agree to pay a predetermined sum slightly greater than the accepted percentage of the cost of the merchantable item, e.g. 2.01%. In return for paying an increased predetermined sum, the merchant will be assured that his advertisement will be displayed near, or at the top of a list of merchantable items when a potential customer searches for the given merchantable item via the service provider website. Even though the merchant pays an increased predetermined sum, a customer will receive his remuneration based on the nominal predetermined sum.

Service provider website 10 is provided with a database 5 in which is stored the user account information of customers and advertisers as well as a listing of displayable advertisements that are associated with corresponding merchantable items, search engine 8 by which merchantable items are searchable, server 9 for communicating with Internet 12, or any other suitable data network, and for loading a web page retrieved by search engine 8. Customer terminals 20 in communication with Internet 12 can interact with service provider website 10 in order to view an advertisement and to subsequently purchase a desired merchantable item. Payment software module 15 in communication with server 9 is adapted to execute a transaction from a customer to a merchant, from the service provider to a customer, or from an advertiser to the service provider. Monitoring software module 18 in communication with server 9 is adapted to determine which users, by means of the service provider website, loaded a given advertisement and which users consummated a purchase by means of the service provider website. Purchase verifying software module 19 interfacing with monitoring software module 18 and information obtainable from a credit card company, e.g. by means of server 40 of a credit card company as illustrated, is adapted to determine which users purchased a merchantable item after loading the advertisement of the merchantable item by means of the service provider website. The function of these software modules will be described hereinafter.

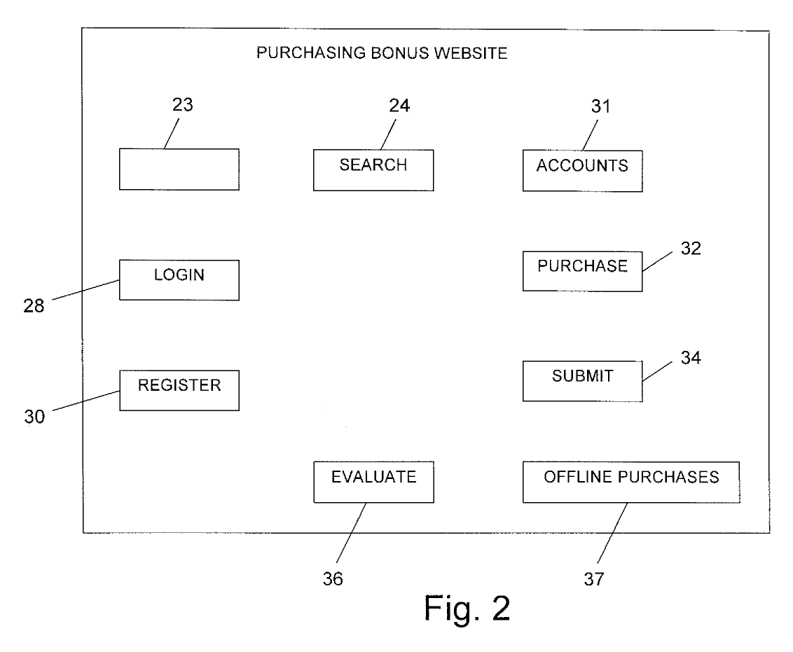

FIG. 2 illustrates an exemplary web page 25 of the service provider website. Web page 25 is provided with field 23 by which advertisements associated with a desired merchantable item can be searched, login button 28 whereby registered users, i.e. customers and advertisers, can perform the login procedure by entering the corresponding username and password in order to review account information or to purchase a merchantable item, registration button 30 for new users, account button 31 to allow users to view their account information, purchase button 32 to initiate a purchase, submit button 34 which is pressed upon consummation of the purchase, evaluate button 36, and offline purchase button 37. The function of these buttons will be described hereinafter. Most of these buttons, excluding login button 28 and registration button 30, are accessible on all web pages that are loaded by means of the service provider website.

A merchantable item to be searched is entered in field 23. After search button 24 is depressed, a list of advertisements associated with the entered merchantable item is displayed. When one of the advertisement listings is selected, a web page of the selected advertisement listing (hereinafter “merchant web page”) is loaded, whereupon a potential customer can determine the characteristics of the corresponding merchantable items being advertised, including price, efficiency, and reliability. The service provider website serves as a portal, and a potential customer that decides to purchase a selected merchantable item after depressing purchase button 32 and entering his payment information, such as credit card number or bank account number for a bank transfer, and then depressing submit button 34 is eligible to receive a remuneration from the service provider.

One of the main benefits of the service provider website to a potential customer is the large increase of advertisements for each merchantable item, since a merchantable item may be advertised for free. Each merchant generally advertises a plurality of merchantable items, and there will invariably be a large number of advertisements for each type and for each group of merchantable items. The price of merchantable items will tend to decrease due to the increase in the number of advertisements, and the quality of the merchantable items will tend to increase.

To assist a potential customer in obtaining information regarding a desired merchantable item, search engine 8 (FIG. 1) is adapted to facilitate the searching process by helping to define what information is needed. For example, if the potential customer entered “washing machine”, a window will be displayed in which 10 types of washing machines are listed. After a washing machine type is selected, 5 models are listed so that the potential customer may obtain the information that he is seeking. At times, the search words that the potential customer chose do not adequately define a merchantable item, and then the search engine generates questions to help the potential customer to define a merchantable item category. The search engine is constantly updated with respect to the search words that the potential customer entered and to the displayed listing that that the potential customer selected, and is therefore able to determine the intent of the potential customer. The search engine may also limit the merchantable items to be displayed by the geographical region of the potential customer, which is entered during user registration.

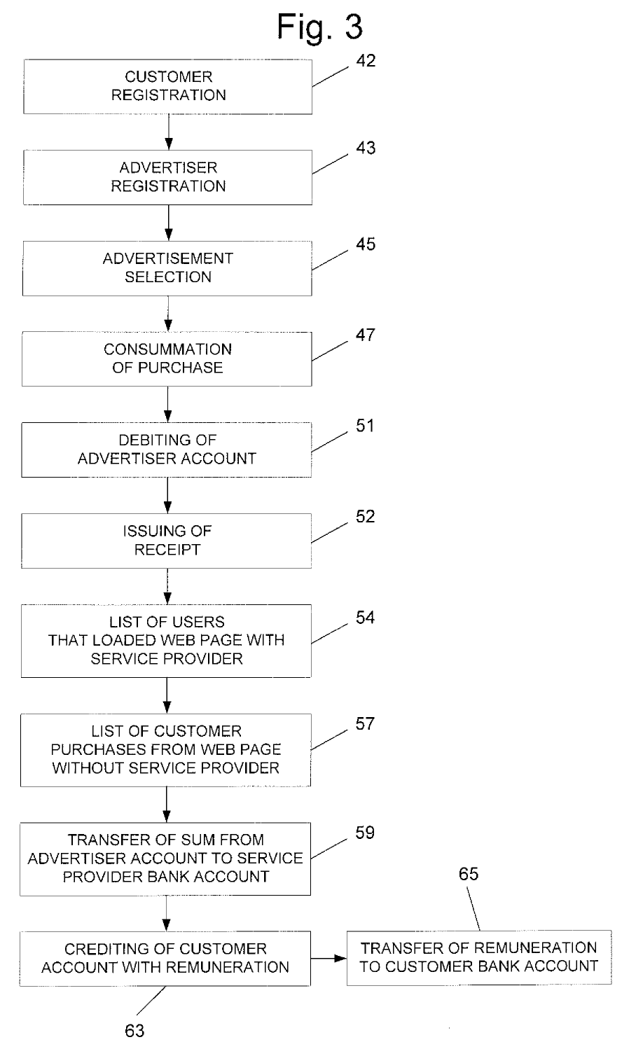

FIG. 3 illustrates a method for promoting advertisement generated revenue, according to one embodiment of the invention. When a customer registers in step 42, he must enter his name identically to that which is associated with his payment information, so that his user account will be properly credited after purchasing a merchantable item advertised in the service provider website. He must also enter the geographical region of his home, gender, and age if he is desirous to engage in evaluations of merchantable items, as will be described hereinafter. A registered customer also needs to enter his bank account number to which the remunerations credited to his user account will be transferred. If the customer authorizes a specified representative during registration to purchase merchantable items, the user account of the customer will also be credited when the specified representative conducts a purchase. During registration, a customer is also requested to sign a waiver which grants permission to a credit card company server to inform the service provider website for verification purposes that the customer consummated a purchase via a merchant web page.

When an advertiser registers in step 43, the URL address of all merchant web pages that are desired to be advertised by the service provider website must be specified, so as to incur the payment of the predetermined sum to the service provider if an advertised merchantable item is purchased. A registered advertiser also needs to enter his bank account number from which the predetermined sums debited to his user account will be transferred to a service provider bank account. The registered advertiser also has to debit his user account by a predetermined security sum, to ensure that the predetermined sums accrued as a result of various customer initiated purchases will be payable. If the predetermined security sum is depleted, the corresponding merchant web pages will not be able to be loaded by potential customers. During registration, an advertiser is also requested to sign a waiver which grants permission to the service provider to transfer names of users that loaded a merchant web page to a credit card company server. A merchant web page that is not specified by the advertiser will be prevented from advertising by means of the service provider website.

After selecting and viewing a displayed advertisement in step 45, the customer or authorized representative thereof decides to purchase the advertised merchantable item in step 47. After the purchase is consummated by transmitting the payment information, the advertiser user account is debited by the predetermined sum in step 51 and the advertiser is obliged to issue a receipt to the customer in step 52. The advertiser is exempt from paying the predetermined sum for additional purchases of the same merchantable item completed by the same customer during a predetermined period, e.g. three months, from the date of the first purchase. The advertiser transmits the receipt to the customer by e-mail, or any other mutually convenient way.

The advertiser is also obliged to pay the predetermined sum to the service provider if the customer purchased the merchantable item from the merchant, whether online or offline, without use of the service provider website within a predetermined period, e.g. three months, after first viewing the advertisement on the merchant web page. On a regular basis, e.g. on a monthly basis, the service provider, by means of the monitoring software module, generates a list in step 54 of those users that loaded a given merchant web page via the service provider website, and then generates a list in step 57 on a regular basis, e.g. once every three months, by means of the purchase verifying software module of those users that consummated a purchase from the merchant web page without use of the service provider website and of the total sum that the advertiser is obliged to pay to the service provider as a result of these purchases. The purchase verifying software module determines that the user consummated a purchase from the merchant by means of a file transmitted by the merchant to the service provider server. Such a file is generated by a credit card company and is indicative of those people that purchased the merchantable item from the merchant and of the sum of the corresponding purchase. Alternatively, the service provider makes a working agreement with a credit card company, after receiving permission from corresponding service provider users, whereby the purchasing history of specified credit card holders with respect to specified merchants is to be transmitted from credit card server 40 to service provider server 19 (FIG. 1). The sum that the advertiser is obliged to pay to the service provider as a result of purchases consummated without use of the service provider website is also determined. If the advertiser does not contest these lists, the grand total sum will be transferred from the advertiser user account in step 59 to a service provider bank account.

The service provider then credits each customer user account in step 63 with a remuneration corresponding to a predetermined percentage of the predetermined sum transferred to the service provider bank account as a result of the corresponding completed purchase or purchases. A remuneration is transferred in step 65 from the service provider bank account to the customer bank account after the balance of the customer user account is grater than a predetermined sum, e.g. $200, so as to reduce bank fees. The currency of the predetermined sum transferred from the advertiser bank account to the service provider bank account and of the remuneration transferred from the service provider bank account to the customer bank account is the currency used by the country of the merchant web page by which the purchase was completed. The receipt transmitted to a customer from an advertiser constitutes proof of a purchase during any occurrence of doubt.

In another embodiment of the invention, a user may receive a remuneration from the service provider for a merchantable item purchased offline from a merchant after viewing an advertisement thereof via the service provider website. In this embodiment, the merchant is a distributor, salesman, store owner, manufacturer, or any other representative of the advertiser.

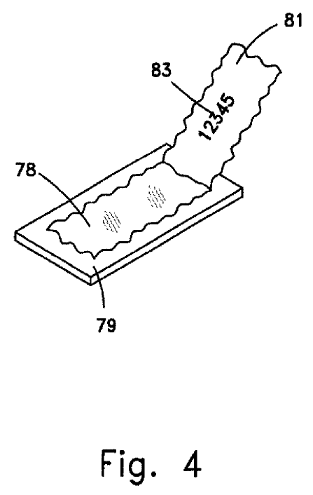

As shown in FIG. 4, merchantable item 78 has a wrapping 79 on the inner face 81 of which is printed a serial number 83 of the merchantable item. A customer accordingly may be able to see serial number 83 only after merchantable item 78 is purchased. After consummating the purchase, the customer accesses the service provider website and depresses offline purchase button 37 (FIG. 2), whereupon a suitable window is displayed in which the customer is requested to enter the type of merchantable item and serial number that was purchased. By having to access the merchant web page a second time, after the first time prior to purchasing the merchantable item, the customer is therefore further exposed to the information advertised on the merchant web page concerning the advantages and uniqueness of the merchantable item.

Following submission of the offline purchase information, the service provider debits the advertiser account by the predetermined sum and credits the customer account by the corresponding remuneration, unless the merchant contests the proof of purchase. In this fashion, a merchant may advantageously benefit from a free advertisement that is accessible by a large viewing audience of potential customers.

By providing advertising and purchasing capabilities, which are beneficial to both customers and merchants, for a plurality of merchantable item categories in one website, the service provider can also function as an intermediary between a customer and merchant. If a customer feels dissatisfaction regarding a purchased merchantable item, he can transmit a message, e.g. an e-mail message, to the service provider in which he notifies the service provider of the cause of dissatisfaction, e.g. the purchased item was defective or the customer was charged a price greater than was advertised on the merchant web page. The message will be transmitted to the merchant web page, and if the merchant responds, the service provider will forward the reply to the customer. If the customer remains dissatisfied, representatives of the service provider will investigate the cause of customer dissatisfaction, and will suggest actions to correct the matter. If a merchant is proved to have consummated a transaction in an unethical manner several times, he may be prevented from advertising on the service provider website. Conversely, if a customer is proved to have unjustifiably claimed a remuneration several times from the service provider, after corresponding merchants refuted that a merchantable item was purchased from the corresponding merchant web page by the customer, the service provider may prevent the customer from interacting with the service provider website, such as by denying authorized access after login or by denying purchasing privileges.

In another embodiment of the invention, a customer that has purchased a merchantable item can evaluate the purchased item, for the benefit of potential customers. A potential customer usually cannot receive an objective evaluation of a merchantable item from a merchant or an advertiser who is attempting to encourage the potential customer to purchase the item. A potential customer at times, on the other hand, receives a degrading opinion of the merchantable item from one that is not completely aware of its characteristics, and therefore an objective evaluation of the merchantable item would be desirable.

To provide a user with an objective evaluation of merchantable items, the service provider offers each customer that has purchased and has had use of a merchantable item the possibility to evaluate the purchased item with respect to a list of predetermined parameters such as price, functionality, reliability, merchant trustworthiness, delivery time, feeling of prestige when being used, and purchasing enjoyment. The service provider prepares a master list of parameters to be evaluated, and the administrator of each merchant page selects those parameters that are applicable to a given merchantable item. The merchant selected parameters are stored in the database 5 (FIG. 1) and are associated with the corresponding web page. A customer may then rate his satisfaction of the purchased item with respect to a given parameter on a scale of 1 to 10. Since customers have varied preferences, expectations, and optimistic or pessimistic tendencies, the ratings of each customer will be averaged and then presented to potential customers on demand. The ratings of each parameter may also be averaged and weighed. For example, if the rating of a customer for a given parameter is generally 2 and for the purchased item being evaluated is 10, such an unexpected change in the rating tendency has more influence on potential customers than a rating that reflects his normal rating tendencies. The service provider then squares the unexpected rating of 10 and divides the result by the average rating of 2, resulting in a weighted rating of 50. Conversely, if the average rating of a customer is 9, and for the purchased item being evaluated the rating is an unexpected rating of 4, the weighted rating will be 16/9=1.7. The weighted rating will be averaged with the ratings of other customers for a given purchased item. The evaluation is stored in the service provider database and is associated with a merchant web page. A customer may receive a suitable prize, such as a lottery ticket, an incentive to participate in the evaluation.

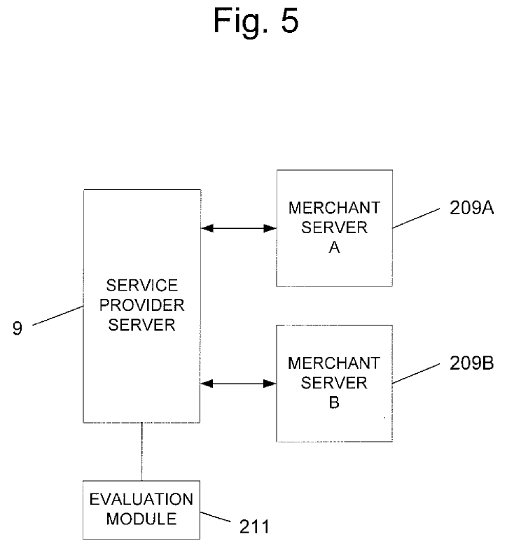

As illustrated in FIG. 5, service provider server 9 has an evaluation module 211, by which customers may rate purchased items. Merchant servers 209A and 209B of corresponding merchant web pages in communication with service provider server 9 allow potential customers to interact with the various software modules of the server 9. Consequently when a potential customer loads a merchant web page during a period of indecision prior to purchasing a selected merchantable item via the service provider website, the merchantable item evaluations are retrieved from the database.

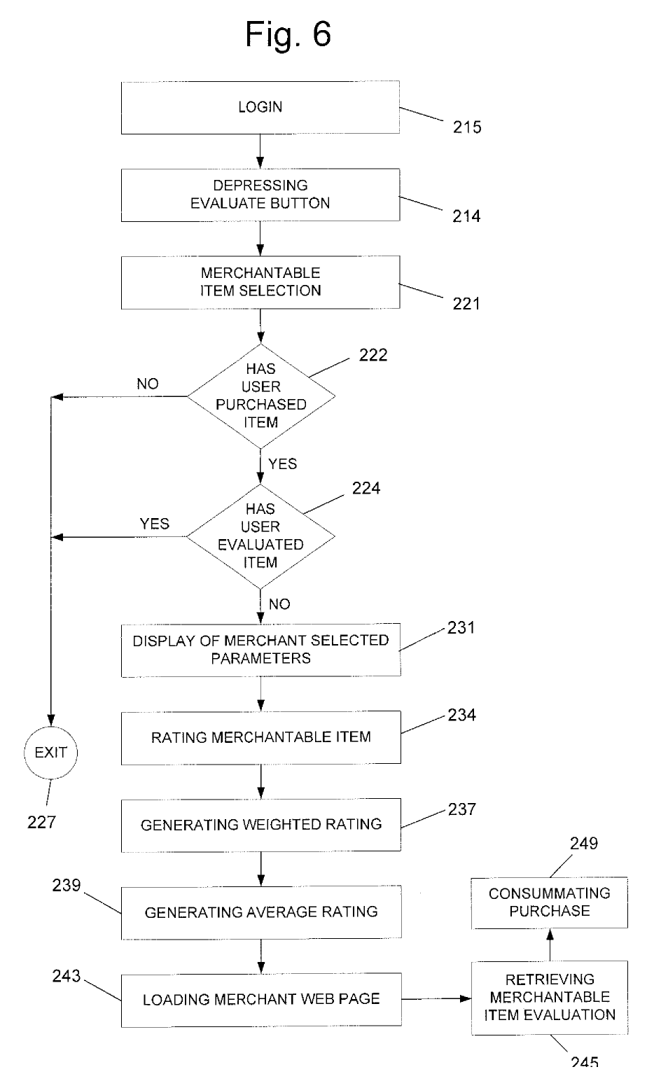

FIG. 6 illustrates the method of evaluating a merchantable item. A user first logs in to the service provider website in step 215 by entering his username and password, and then depresses evaluate button 36 (FIG. 2) in step 217. The user selects in step 221 a merchantable item that he is desirous of evaluating. An item selection is made by entering an item description in field 23 and then depressing search button 24 (FIG. 2). If the entered item description is not sufficiently specific, a list of merchantable item categories associated with the entered item description is displayed. After selection of a category, a list of specific merchantable items and associated URL address is displayed. After selection of a specific merchantable item, the service provider server determines in step 222 whether the user has purchased the item and determines in step 224 whether he has submitted an evaluation of the specific merchantable item within a predetermined period, e.g. 3 months. If the service provider server determines that the user has not purchased the item or determines that he has submitted an evaluation of the specific merchantable item within the predetermined period, the user is prevented in step 227 from participating in the evaluation.

When the user is permitted to participate in the evaluation, the merchant selected parameters are displayed in step 231. The user then rates the merchantable item with respect to one or more of the displayed parameters in step 234 and submits the evaluation, e.g. by depressing submit button 34 (FIG. 2). After a plurality of evaluations for the specific merchantable item has been submitted, the evaluation module generates a weighted rating for each submitted evaluation in step 237 and generates an average rating in step 239 for the specific merchantable item or for one of its parameters. The generated rating is stored in the database and associated with the merchant web page.

When a potential customer loads a merchant web page in step 243 during a period of indecision prior to purchasing a selected merchantable item via the service provider website, he may retrieve a merchantable item evaluation in step 245 from the database by depressing evaluate button 36. A potential customer may receive further details concerning the evaluation by suitable interaction with the merchant web page, such as number of users that participated in the evaluation and a profile of the various geographic regions, gender and age of the participants in the evaluation. The potential customer may be influenced by a sufficiently favorable evaluation of the selected merchantable item such that he will be encouraged to consummate a purchase by depressing purchase button 32 (FIG. 2) in step 249.

In another embodiment of the invention, the service provider website also displays advertisements of non-merchantable items, on demand, to users.

One example of non-merchantable items that can be advertised with use of the service provider website is an advertisement for political purposes. A candidate is allowed to advertise initially for free, and will be required to pay a predetermined sum to the service provider if he succeeds in the upcoming elections. The term “candidate” includes reference to a political party. To “succeed” in the elections is generally defined as being elected for a desired political position; however, a candidate may define any other level of political success, such as a desired number of seats to be awarded in a legislative assembly. During the course of the campaign, a candidate can redefine the desired level of political success. If a candidate redefined the desired level of political success, the predetermined sum that the candidate will be retroactively obliged to pay will be based on the originally defined level of success. A user will be eligible for a remuneration from the service provider only if he submitted a request to receive propaganda via e-mail from a candidate web page (hereinafter “registered”), subsequently loaded the candidate web page, and the candidate was found to have succeeded in the elections.

During registration, such as by depressing register button 30 (FIG. 2) or by e-mail, a candidate must specify, in addition to payment information, election information, such as the name of the candidate, the date of the election, which political position is being elected, and in which geographical location the election will be held. Furthermore, the candidate must specify the URL address of all candidate web pages that are desired to be advertised by the service provider website, so as to incur the payment of a predetermined sum to the service provider based on the number of users that loaded a candidate web page. Due to the large predetermined sum that the candidate must pay the service provider if he succeeds in the election, the candidate is required to make an advance payment corresponding to approximately the number of candidate-specific registered users.

A user is allowed to be registered in only one candidate web page. The service provider server is capable of determining that a user who is desirous of registering in a first candidate web page is already registered in a second candidate web page, and will therefore prevent the user from registering in the first candidate web page, unless he rescinds his registration in the second candidate web page. The service provider server will also prevent a user from registering to a candidate web page if the stored user geographical location is not compatible with the stored election geographical location, or if the age of the user is less than the minimum voting age.

Other examples of non-merchantable items that can be advertised with use of the service provider website are advertisements of non-profit organizations, such as to encourage people to stop smoking or to drive carefully, notices generated by public organizations, such as a timetable or a notice that a governmental office will be unexpectedly closed, and an advertisement of a gathering such as a lecture or a fundraising event. The advertiser will be obliged to pay the predetermined sum to the service provider if a predetermined number of users will load the corresponding advertiser web page.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for promoting advertisement generated revenue, comprising the following steps:
a) Providing a service provider website suitable for searching and loading each of a plurality of stored advertiser web pages which are displayable without any initial advertising costs;
b) User-initiated loading of a selected advertiser web page;
c) Debiting an advertiser account by a predetermined sum upon completion of an advertiser chargeable operation associated by predetermined criteria with said loading of said selected advertiser web page; and
d) Crediting a user account with a service provider payable remuneration, the value of said remuneration being based on said predetermined sum debited to said advertiser account.

2. The method according to claim 1, wherein the advertiser chargeable operation is a purchase of a merchantable item.

3. The method according to claim 2, wherein the advertisement generated revenue is accrued by performing the following steps:
a) Loading a merchant web page and viewing a corresponding advertisement of a merchantable item;
b) Submitting a request to purchase said merchantable item;
c) Consummating a customer-initiated purchase of said merchantable item by transmitting payment information;
d) Debiting the advertiser account by the predetermined sum;
e) Issuing a receipt to the customer for said purchase;
f) Transferring the predetermined sum to a service provider bank account;
g) Crediting the user account with the service provider payable remuneration; and
h) Transferring the remuneration from the service provider bank account to a customer bank account after the balance of the user account is greater than a predetermined balance.

4. The method according to claim 1, wherein the advertiser chargeable operation is candidate success in a predetermined election.

5. A system for promoting advertisement generated revenue, comprising:
a) A service provider website dedicated to displaying a plurality of advertisements for various types of merchantable items which are displayable without any initial advertising costs, said service provider website comprising-
i. a database in which are stored customer and merchant account information and a listing of displayable advertisements associated with corresponding merchantable items;
ii. a search engine by which merchantable items are searchable;
iii. a server for communicating with a suitable data network and for loading a merchant web page retrieved by said search engine;
iv. a payment module in communication with said server adapted to execute a transaction from a customer to a merchant, from the service provider to a customer, or from an advertiser to the service provider;
v. a monitoring module in communication with said server adapted to determine which customers, by means of the service provider website, loaded a given merchant web page and which customers consummated a purchase by means of the service provider website; and
vi. a purchase verifying module interfacing with said monitoring module and information obtainable from a credit card company, said purchase verifying module adapted to determine which customers purchased a merchantable item after loading the advertisement of the merchantable item by means of the service provider website; and
b) a plurality of customer terminals in communication with said data network, for interacting with said service provider website,
wherein a purchase is capable of being consummated by means of a customer terminal and said payment module following the loading of a selected advertiser web page and the entering of suitable payment information, said server being operable to automatically debit a merchant account by a predetermined sum and to automatically credit a customer account by a remuneration the value of which being based on said predetermined sum upon consummation of said purchase.
